(19) United States
(12) Patent Application Publication
(10) Pub. No.: US 2007/0290504 A1
(43) Pub. Date: Dec. 20, 2007

(54) Diode assembly and method of forming same

(76) Inventor: Oliver Mou, North Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/452,484

(22) Filed: Jun. 14, 2006

(51) Int. Cl. F16L 21/02

(52) U.S. Cl. 285/369

(57) ABSTRACT

A diode assembly comprises a diode, an electrical lead extending from the diode and a pre-fabricated connector placing the lead of the diode in electrical communication with another electrical component or an electrical circuit, such as a resistor. Preferably, the pre-fabricated connector comprises a tubular sleeve. In use, the leads are placed into openings at ends of the sleeve and the sleeve is preferably crimped so that it mechanically engages the leads. In one embodiment, the connector forms a conductive path between the leads or places the leads in direct contact.

### TECHNICAL FIELD

The present invention relates generally to electrical circuit components, and more particularly, to a method and apparatus for connecting a diode to an electrical circuit or electrical circuit component.

### BACKGROUND OF THE INVENTION

The use of diodes to perform functions in electrical circuits have become commonplace. One of the most common uses is as a light emitting diode or LED.

As generalized background, a diode in its simplest description acts as a one-way valve for the direction of movement of an electrical charge. More particularly, it allows an electric current to flow in one direction, but blocks the return flow in the opposite direction.

Most modern diodes take the form of semiconductor chips. The diode chips are constructed to have two different layers of differing materials, one identified as a layer of P-type material and the other identified as a layer of N-type material. The letter “P” designates this particular layer as having extra positively charged particles and the letter “N” identifies this specific layer as having extra negatively charged particles. The P-type layer and the N-type layer are bonded together in a conventional fashion. The area of bonding between the two layers is described as the P-N junction. Electrodes are coupled to the chip at opposing ends or portions thereof, one to the P-type layer and one to the N-type layer.

The negatively charged particles (commonly known as electrons) tend to migrate toward the positively charged particles. Thus, when the diode is in a free state, some of the extra electrons move from the N-type layer to the P-type layer, creating an insulating zone along the P-N junction in the middle of the diode called the depletion zone.

To eliminate the depletion zone, more of the extra electrons must be made to migrate from the N-type layer to the P-type layer. This is accomplished by configuring the circuit with the negative electrode attached to the N-type layer and the positive electrode attached to the P-type layer and applying a voltage. The extra electrons in the N-type layer are repelled by the negative electrode and drawn to the positive electrode. When the voltage difference between the electrodes is high enough, electrons in the insulating or depletion zone are urged to move. The depletion zone vanishes and current flows across the P-N junction.

When considering the physical make-up of the diode, it can thus be appreciated that current can only flow in one direction. More specifically, if the P-type layer is connected to the negative electrode and the N-type layer is connected to the positive electrode, the electrical attraction in each layer is toward the adjacent electrode and away from the junction. In this configuration, the depletion zone is enlarged and no current can cross the junction.

In operation, as current passes across the P-N junction, the moving electrons emit photons. This characteristic can be utilized by using certain materials and a correct geometry to make the light created by the photons become visible. Thus, the specific type of diode identified as an LED is created. An LED can provide a useful display function when utilized in a variety of operational environments.

One environment where LEDs have come into common use is as a replacement to incandescent lighting. LEDs do not have a filament that ultimately burns out, so their life is much longer. Most importantly, with incandescent bulbs, the light-producing process requires the filament to be warmed, generating a lot of heat and thus wasted energy. With LEDs, a much higher percentage of the applied electrical power is directed to generating light. Many forms of signage and image displays have taken to using LEDs in order to both increase the efficiency and life expectancy of the light-emitting assembly.

For example, one new use of LEDs is in illuminating gaming machine buttons. Casinos may have many thousands of machines, each with a plurality of illuminated push-buttons. Significant resources must be expended to maintain standard incandescent bulbs of such buttons, owing to the fact that the bulbs burn out frequently and at different times. The use of LEDs significantly reduces the effort needed to maintain these buttons.

Because LEDs have so many different applications, they are generally formed as an individual element. The chip is formed with a pair of electrical leads. The chip is then encased in a protective material, such as a low-temperature activated plastic. In this configuration, the LED can be connected to other electronic components or an electrical circuit.

In the case of gaming machine push-buttons, in order to distinguish between their functionality or, alternatively, to simply create a more interesting visual presentation, it is often desirable for an LED to be configured to emit a specific color of light. This is achieved in one design configuration by applying a specific voltage to the LED. As an example, to produce the color known in the art as cold white, an amount of approximately three volts is needed to pass through the LED. The passing of voltages of other specific amounts through an LED results in the emission of different colors across the visible spectrum.

Since most gaming machines operate at much higher voltages which, when applied to LEDs, do not create light emissions within the visible spectrum, i.e. 6.3, 12 or 24 volts, it becomes necessary to adjust the voltage flowing to each LED to produce its desired color emission. This essentially requires a “modification” to the LED in which a resistor is associated with the LED to reduce the voltage applied to the LED. It can be appreciated that by using a resistor with specific desired characteristics to reduce the current flowing to an LED, the desired color is created for visible recognition.

Heretofore, the conventional technique of connecting the LED to the resistor has been by soldering one or more of the leads of a resistor to a lead or leads of the LED. In this process, a fusible metal alloy is melted to join the metal leads of the LED and resistor. As is generally known, the solder alloy is conductive and thus the circuit created using the solder material is capable of allowing the efficient flow of current. In the solder operation, the melted solder alloy flows around the electrical leads of two components in the circuit and after re-solidifying, forms a mechanical and electrically conductive connection between the leads of the two components.

As is known in the art, however, the melting of the solder alloy requires the application of significant heat. The heat which is needed to melt the solder or heat from the melted solder is transferred to the associated leads which are being joined. This heat is readily conducted along the electrical leads to the LED chip. Unfortunately, LED chips are very heat sensitive and this transferred heat often damages the LED. In some cases, upwards of 40% of LEDs may be damaged during this connection process, resulting in undesirable discrepancies in color emission or even complete inoperability when the diode is severely heat-damaged.

As one attempt at solving this problem, some parties have utilized LEDs with very long leads and then associated the resistor with the end of the lead. In this manner, heat generated during the soldering process may dissipate as it travels up the long lead. This solution has a number of problems. It can be appreciated that there is limited space within a gaming machine push-button and thus the electrical circuitry that includes the LED and the associated resistor requires precise positioning for desired operation. The LED needs to be set back enough from the top of the button for proper light distribution and the entire diode/resistor assembly needs to be short enough to fit within the button. To properly place LEDs with long leads, the leads must be bent, such as in a zigzag pattern so that the effective length of the lead is small. However, this presents separate problems of safety and efficiency of current transmission and therefore is not an adequate solution.

LED production is rather difficult and has only just started to reach levels of efficiency where they have become cost effective to produce compared to their benefits in use. These production gains are offset, however, by the rather high percentage of LEDs which are subsequently damaged in this later assembly process. Because so many LEDs are damaged, the cost of producing LED assemblies is raised significantly.

### SUMMARY OF THE INVENTION

The present invention is a diode assembly and a method of forming a diode assembly.

The assembly preferably comprises a diode, constructed in accordance with its particular purpose, and at least one electrical lead extending from the diode. In an important aspect of the invention, the assembly further comprises a connector configured to attach the electrical lead of the diode to another element, such the lead of a resistor.

In accordance with one embodiment of the present invention, the connector is a pre-fabricated element which is configured to engage at least one lead of the diode and an element to which the diode is to be connected, preferably another electrical component or an electrical circuit. In one embodiment, the other element comprises a resistor and the connector is configured to engage a lead of the resistor.

In one embodiment, the pre-fabricated connector comprises a sleeve. The sleeve has an opening at both ends or passage entirely therethrough, whereby the sleeve is configured to accept a pair of leads inserted into it at opposing ends thereof. Depending on its particular use and environment, the sleeve may be constructed of either electrically conductive material or electrically non-conductive material.

In one embodiment, the configuration of the connector can be changed from one in which it accepts a lead or leads of the diode and electrical component or circuit, and another configuration where it engages or secures those leads. In one embodiment, the sleeve is collapsible, permitting the sleeve to be crimped to facilitate a connection between the diode lead and electrical component or electrical circuit lead. For example, the sleeve may be tubular and defined by a wall. The wall may be crimped so that one or more portions thereof collapse upon the leads and engage them. The connector may be configured to change configuration or otherwise form the desired connection in other fashions, such as by bradding, clamping, riveting and stapling.

The present invention further contemplates a method for connecting a diode to an electrical circuit or circuit element, such as a resistor. In its preferred embodiment, the method comprises providing a pre-fabricated connector having open ends. Additionally, the method includes a step of positioning an electrical lead from the diode and an electrical lead from the circuit within the open ends of the connector. In one embodiment, the method further includes the step of changing a configuration of or manipulating the connector so that it connects or joins the leads.

In a preferred aspect of the method, the manipulating step comprises crimping the pre-fabricated connector. While the connector can take on a variety of configurations, one embodiment of the method provides for the use of a sleeve, and most preferably, a tubular sleeve.

Preferably, the connector forms a mechanical connection with each of the leads. In addition, the connector preferably results in the leads being placed into electrical communication with one another. In one embodiment, the connector forms an electrically conductive path between the leads. Alternatively or in addition, the connector may maintain the leads in direct contact with one another.

Still other objects of the present invention will become apparent to those skilled in this art from the following description wherein there is shown and described a preferred embodiment of this invention, simply way of illustration of one of modes best suited to carry out the invention. As will be realized, the invention is capable of other different embodiments and its several details are capable of modification in various, obvious aspects all without departing from the spirit and scope of the invention. Accordingly, the drawings and descriptions will be regarded as illustrative in nature and not as restrictive.

### DESCRIPTION OF THE DRAWINGS

The accompanying drawings incorporated in and forming a part of this specification illustrates several aspects of the present invention and together with the description serves to explain the principles of the invention. In the drawings:

FIG. 1 is a schematic illustration of a partial circuit including a diode and a resistor in operational relation;

FIG. 2 is an enlarged schematic illustration of a diode that is contemplated for use in the present invention;

FIG. 3 is a side view of a diode assembly in accordance with the present invention;

FIG. 4 is a cross-sectional view of a tubular sleeve in accordance with one embodiment of the present invention; and

FIG. 5 is cross-sectional view of the tubular sleeve of FIG. 4 and shown in its operational environment as taken across lines 5-5 in FIG. 3.

Reference will now be made in detail to the present preferred embodiment of the invention, an example of which is illustrated in the accompanying drawings.

### DETAILED DESCRIPTION OF THE INVENTION

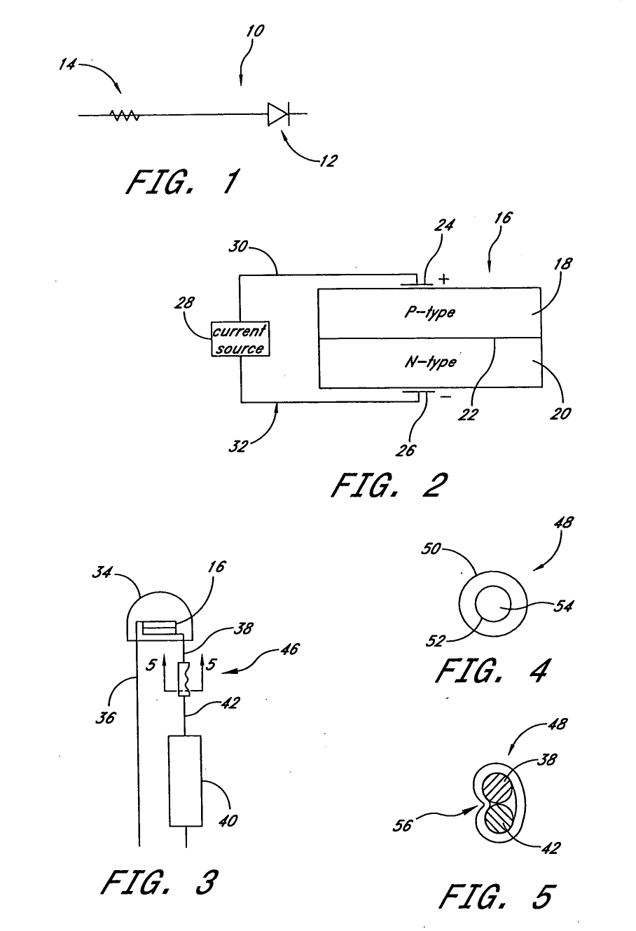

The present invention is contemplated for use in electrical circuitry. Generally, diodes are used in an electrical circuit in combination with other components. FIG. 1 shows, in schematic form, a partial circuit 10 that incorporates a light emitting diode (LED) 12 and a resistor 14 in operational relation. While an LED 12 is illustrated, it is contemplated that the inventive assembly could be used with any type of diode. It is thus not intended by this description to limit the diode assembly simply to diodes constructed to be light emitting diodes.

In FIG. 2, a diode 16 of the type contemplated for use in the present invention is illustrated. The diode 16 is constructed in accordance with familiar manufacturing techniques and has chip layers 18 and 20. The chip layers 18 and 20 are separated at a junction 22.

As shown in the drawing, the chip layer 18 is identified as comprising P-type material and the chip layer 20 is identified as being constructed of N-type material. The junction 22 is formed by the bonding of the P-type chip layer 18 to the N-type chip layer 20. Electrodes 24 and 26 are attached to the P-type chip layer 18 and N-type chip layer 20, respectively, on opposite sides of the diode 16. The electrodes 24,26 are preferably connected through conventional electrical circuitry to a current source 28 by electrical leads 30,32, respectively.

As is known by those skilled in the diode art, the P-type chip layer 18 is formed of material giving it a positively charged state. Further, the N-type chip layer 20 is constructed of material to configure it to be presented in a negatively charged state. The existence of a positively charged state in the P-type material is created by an overabundance of positively charged particles. Likewise, an excess of negatively charged particles in the N-type material results in it being in a negatively charged state. Simply put, the N-type material has an oversupply of electrons and the P-type material has an under supply of electrons. As is commonly known in the scientific world, electrons are attracted by a positive electrode and repelled by a negative electrode.

Since diodes are created to function by allowing current to travel in only one direction, it is important to establish the electrodes 24,26 in the proper configuration. With the structure of the diode 16 depicted in FIG. 2, this occurs when electrode 24 is a positive electrode and electrode 26 is a negative electrode. Thus, when the current source 28 energizes the electrodes 24,26 to produce a sufficient voltage drop, electrons will be attracted by the positive electrode 24 (note the adjacent “plus” sign) and repelled by the negative electrode 26 (note the adjacent “minus” sign). This creates a flow of electrons, defining a current, from the N-type chip layer 20 to the P-type chip layer 18 across the P-N junction 22.

For an explanation regarding the inability of current to flow in the diode 16 in the reverse direction, reference is made to the general discussion of diode operation in the Background of the Invention section.

FIG. 3 shows the diode 16 in a conventional construction, although not necessarily to scale, as may be presented for use as a light emitting diode, more commonly referred to by its acronym LED. Thus, the schematic presentation of the LED 12 in FIG. 1 can be considered equivalent to the diode 16 as shown FIGS. 3 for purposes of this application. As stated previously, however, it is contemplated that the diode assembly of the present invention incorporate any manner or form of diode as implemented for any useful purpose.

As illustrated in FIG. 3, the light emitting diode 16 is preferably located within an envelope, housing or other protective structure or material 34. For example, the diode 16 may be located within plastic material. The electrical leads 36,38 from the diode 16 extend from the envelope 34. The leads 36,38 are connected in conventional form to electrodes attached to the diode 16. As such, the leads 36,38 are equivalent to leads 30,32 as shown in FIG. 2, with the evident implication that electrodes equivalent to 24,26 as shown in FIG. 2 exist but are not depicted therein so as to not obscure the invention.

In accordance with the invention, an apparatus is provided for connecting the diode 16 to another electrical component or an electrical circuit. In a preferred embodiment, the apparatus is configured to connect the diode 16 to a resistor. The apparatus may be useful, however, in connecting the diode 16 to other or additional electrical components, either in series or in parallel relation, or to electrical circuits. For example, a separate diode may be included in the circuit with the illustrated diode 16. This separate diode may act as a current-blocking or a current-rectifying diode relative to the light-emitting diode 16. For example, a current-rectifying diode maybe utilized so that the LED maybe connected to the circuit without regard to polarity. This is particularly advantageous relative to gaming machine buttons in that a technician who replaces a button LED need not ensure that the leads of the LED be matched specifically to the polarity of the contacts at the socket. Such a secondary diode can also or alternatively be used to prevent excessive current from surging the light-emitting diode 16 and causing damage.

In accordance the preferred embodiment, FIG. 3 depicts a resistor 40. An electrical lead 42 extends from the resistor 40 for its respective connection to an electrical circuit or other electrical component. The resistor 40 performs its ordinary function in regulating current as is conventionally known.

In accordance with the invention, as illustrated in FIG. 3, a pre-fabricated connector 46 is utilized to couple the lead 38 from the diode 16 to the lead 42 of to the resistor 40. The pre-fabricated connector 46 is contemplated as being a form of useful fastening means that does not require application of heat to form the connection of the leads. In the preferred embodiment of the invention, as more particularly shown in FIG. 4, the connector 46 takes the form of a tubular sleeve 48. However, it should be appreciated that the pre-fabricated connector 46 may have other structural forms.

In one embodiment the tubular sleeve 48 has a wall with an outer circumference 50 and an inner circumference 52. The sleeve 48 is open at opposing ends, whereby each end is capable of accepting a portion of a lead. In a preferred embodiment, the sleeve 48 defines a passage 54 entirely therethrough. The sleeve 48 is preferably generally straight or linear (as illustrated), but it might have other configurations, such as “L”-shaped or the like.

The connector 46 is preferably configured to engage two associated leads in a manner placing the leads in electrical communication with one another. In one embodiment, the connector 46 or a portion thereof may be electrically conductive, whereby the connector 46 itself forms an electrically conductive path between the two leads. In another embodiment, the connector may maintain the leads in a position in which they contact one another and are in direct electrical communication.

The connector 46 may engage the leads in various manners. Preferably, the connector 46 is capable of forming a mechanical connection with each lead so that the connector remains in contact with both leads, thus ensuring the integrity of the electrically conductive path. The connector 46 may engage the leads in various manners. In one embodiment, the configuration of the connector 46 may be changed from a first configuration in which it readily accepts the leads, to a second position in which it secures or engages the leads.

In particular, in one embodiment, the shape of the connector 46 maybe changed. In the case where the connector 46 comprises a sleeve 48, the sleeve 48 may be configured to collapse. As illustrated in FIG. 5, the position of the wall of the sleeve 48 may be changed, thereby changing the shape of the lead accepting passage and causing the wall to press upon the leads, thus binding them into fixed engagement with the sleeve. In particular, the sleeve 48 may be crimped as shown in area 56 to pinch the lead 38 from the diode 16 against the lead 42 from the resistor 40 and/or pinch the lead 38 from the diode 16 into contact with the sleeve and pinch the lead 42 from the resistor 40 into contact with the sleeve. Thus, as can be appreciated, the crimped sleeve 48 captures and secures the leads 38 and 42, creating a mechanical connection between the leads 38 and 42 and a corresponding electrical connection there between.

The sleeve 48 may alternatively be manipulated in ways other than crimping to create a resulting mechanical connection with it and/or directly between the leads 38 and 42. For example, such elements as clamps, staples, rivets or brads may be employed to bring about the desired mechanical and electrically conductive coupling of the sleeve 48 to the leads 38 and 42 (and/or the leads 38,42 to one another). These examples are not intended to be exhaustive, as any form of manipulating method that permits the sleeve 48 to achieve its intended connecting function is within the scope of the present invention. The connector might have other configurations as well, such as one where the openings/passage are defined by a non-contiguous wall which may be pressed or collapsed (such as to overlap upon itself) or other structures which satisfy the above-stated functions.

As indicated, the pre-fabricated connector 46, in whatever form it may take, may be constructed of electrically conductive material to ensure that electrical communication is achieved and current can flow along the circuit. However, the use of such material is not mandated, such as where the leads 38,42 are placed into direct contact, and as such, electrically non-conductive material can also used in creating the connector 46. In another embodiment, the exterior of the connector 46 might be formed of a non-conductive or insulating material, while the interior thereof(which engages the leads) is constructed of a conductive material.

In a preferred embodiment of the invention, the apparatus comprises a lead connector. The lead connector is, as detailed above, configured to connect at least one lead of the diode 16 to at least one lead of another electrical component or an electrical circuit. The connector might be configured to engage components having other configurations. For example, the connector might be configured to engage a lead of the diode and a circuit board contact.

In summary, numerous benefits have been described which result from employing the concepts of the present invention. Advantageously, the inventive diode assembly results in a simple mechanical connection to form the useful electrical circuit. Importantly, the connection is formed using a method that avoids the application of diode-damaging heat. Thus, safety and efficiency is advanced through the use of the instrumentalities of the present invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment disclosed herein was chosen and described to provide the best illustration of the principles of the invention and its practical application to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally and equitably entitled.

What is claimed is:

1. A diode assembly for connecting to an electrical component, comprising:
a diode;
an electrical lead extending from said diode; and
a pre-fabricated connector for attaching said electrical lead to said electrical component.

2. The diode assembly of claim 1, wherein said electrical component comprises a resistor.

3. The diode assembly of claim 1, wherein said pre-fabricated connector is configured with a passage therethrough.

3. The diode assembly of claim 1, wherein said pre-fabricated connector is constructed of electrically conductive material.

4. The diode assembly of claim 1, wherein pre-fabricated connector defines a first opening therein for accepting said electrical lead extending from said diode and a lead extending from said electrical component.

5. The diode assembly of claim 1, wherein said pre-fabricated connector comprises: a sleeve.

6. The diode assembly of claim 5, wherein said sleeve is constructed of electrically conductive material.

7. The diode assembly of claim 5, wherein said sleeve is tubular.

8. The diode assembly of claim 7, wherein said sleeve is defined by a collapsible wall.

9. The diode assembly of claim 5, wherein said sleeve is crimped to facilitate mechanical connection between it and said diode lead and said circuit.

10. A method for connecting a diode to an electrical component, comprising the steps of:
providing a pre-assembled diode comprising a diode chip located in an enclosure and a pair of electrical leads extending from said chip to the exterior of said enclosure;
providing a pre-fabricated connector having a first opening and a second opening;
positioning an electrical lead from said diode in said first opening and an electrical lead from said component said second opening; and
manipulating said connector to mechanically connect said connector to said leads in a manner causing said leads to be in electrical communication with one another.

11. The method of claim 10, wherein said manipulating step comprises crimping said pre-fabricated connector.

12. The method of claim 10, wherein said pre-fabricated connector comprises sleeve.

13. The method of claim 12, wherein said sleeve is tubular in configuration.

14. The method of claim 10, wherein said pre-fabricated connector is constructed of electrically conductive material.

15. The method of 10, wherein said pre-fabricated connector is constructed of electrically non-conductive material.

16. In combination, a light emitting diode comprising a chip located within an enclosure and a pair of electrical leads extending from said enclosure, an electrical component having at least one lead extending therefrom, and a connector, at least one of said pair of electrical leads extending from said enclosure positioned in a first opening in said connector and said at least one lead extending from said electrical component in a second opening in said connector, said connector mechanically engaging said leads positioned in said first and second openings thereof and placing said leads in electrical communication with one another.

17. The combination of claim 16, wherein said connector defines a passage therethrough, said first and second opening in communication with one another via said passage, and wherein said leads are in direct contact with one another within said passage.

18. The combination of claim 16, wherein said connector defines an electrically conductive pathway between said leads.

19. The combination of claim 16, wherein said connector comprises a tubular sleeve, one or more portions of which are collapsed upon said leads.
